(19) United States
(12) Patent Application Publication
(10) Pub. No.: US 2024/0255911 A1
(43) Pub. Date: Aug. 1, 2024

(54) INPUT-OUTPUT CONTROL CIRCUIT, CONTROLLER, AND AIR CONDITIONER

(71) Applicants: SHANGHAI KONG INTELLIGENT BUILDING CO., LTD., Shanghai (CN); GD MIDEA HEATING & VENTILATING EQUIPMENT CO., LTD., Foshan, Guangdong (CN)

(72) Inventors: Zhen ZHAO, Shanghai (CN); Dayou YANG, Shanghai (CN); Jie YAN, Shanghai (CN)

(73) Assignees: SHANGHAI KONG INTELLIGENT BUILDING CO., LTD., Shanghai (CN); GD MIDEA HEATING & VENTILATING EQUIPMENT CO., LTD., Foshan, Guangdong (CN)

(21) Appl. No.: 18/564,315

(22) PCT Filed: Sep. 5, 2022
(86) PCT No.: PCT/CN2022/117042

§ 371 Date: Nov. 27, 2023

(30) Foreign Application Priority Data
Nov. 1, 2021 (CN) 202111284434.5

(51) Int. Cl. G05B 19/042

(52) U.S. Cl. CPC G05B 19/0423; G05B 2219/2614

(57) ABSTRACT

An input-output control circuit, a controller and an air conditioner are provided. The circuit includes a signal input-output end, a first switch module, a first resistor, a second switch module, a second resistor, a third resistor, a fourth resistor, a fourth switch module, a fifth switch module, an amplification module, a sixth switch module and a control module. The control module outputs a first control signal by a first control end to control the on-off of the second switch module, outputs second control signals by a second control end to correspondingly control the on-off of the second switch module and the third switch module, and outputs a third control signal by a third control end to control the on-off of the fifth switch module.

### CROSS-REFERENCE TO RELATED APPLICATION

The application is based on and claims priority to Chinese Patent Application No. 202111284434.5, filed on Nov. 11, 2021, the entire contents of which are incorporated herein by reference.

### FIELD

The present disclosure relates to the field of electronic technology, and in particular, to an input-output control circuit, a controller and an air conditioner.

### BACKGROUND

With the rapid development of industrial automation, Programmable Logic Controller (PLC) and Direct Digital Control (DDC) controller are increasingly applied in various fields such as industry, transportation, buildings. With the intelligent upgrading of the controller, there is a higher and higher demand on the function of input and output control circuits of the controller.

Therefore, it is of an urgent problem to be solved on how to improve the universality, safety, and reliability of the input and output control circuit.

### SUMMARY

The present disclosure aims to solve at least one of the technical problems in the related art to a certain degree.

For this, a first objective of the present disclosure is to provide an input-output control circuit, thus to convert the input or output signal with simple operations, thereby improving the universality, safety and reliability of the input-output control circuit.

A second objective of the present disclosure is to provide a controller.

A third objective of the present disclosure is to provide an air conditioner.

In order to achieve the above objectives, according to a first aspect of embodiments of the present disclosure, there is provided an input-output control circuit, including: a signal input-output end for inputting or outputting a signal; a first switch module, where a first end of the first switch module is connected to a first direct-current voltage source; a first resistor, where a first end of the first resistor is connected to a second end of the first switch module; a second switch module, where a first end of the second switch module is connected to a third end of the first switch module, a second end of the second switch module is grounded, and a third end of the second switch module is connected to a first control end of a control module; a second resistor, where a first end of the second resistor is connected to the signal input-output end, and a second end of the second resistor is connected to a second direct-current voltage source and an analog-digital conversion end of the control module; a third resistor, where a first end of the third resistor is connected to the signal input-output end; a third switch module, where a first end of the third switch module is connected to a second end of the third resistor, a second end of the third switch module is grounded, and a third end of the third switch module is connected to a second control end of the control module; a fourth resistor, where a first end of the fourth resistor is connected to the second end of the second resistor; a fourth switch module, where a first end of the fourth switch module is connected to a second end of the fourth resistor, and a second end of the fourth switch module is grounded; a fifth switch module, where a first end of the fifth switch module is connected to a third end of the fourth switch module and a third direct-current voltage source, a second end of the fifth switch module is grounded, and a third end of the fifth switch module is connected to the second control end of the control module; an amplification module, where a first end of the amplification module is connected to a digital-analog conversion end of the control module, and a second end of the amplification module is grounded; a sixth switch module, where a first end of the sixth switch module is connected to a third end of the amplification module, a second end of the sixth switch module is connected to the signal input-output end, a third end of the sixth switch module is connected to a third control end of the control module, and a fourth end of the sixth switch module is grounded; and the control module, configured to: control the second switch module to be on or off according to a first control signal output by the first control end; control the fifth switch module and the third switch module to be on or off individually according to a second control signal output by the second control end; and control the sixth switch module to be on or off according to a third control signal output by the third control end, to collect the signal input from the signal input-output end by the analog-digital conversion end, or to output the signal input to the digital-analog conversion end through the signal input-output end.

According to embodiments of the present disclosure, the input-output control circuit includes: the signal input-output end, the first switch module, the first resistor, the second switch module, the second resistor, the third resistor, the third switch module, the fourth resistor, the fourth switch module, the fifth switch module, the amplification module, the sixth switch module and the controller module, where the signal input-output end is for inputting or outputting a signal; the first end of the first switch module is connected to the first direct-current voltage source; the first end of the first resistor is connected to the second end of the first switch module; the first end of the second switch module is connected to the third end of the first switch module, the second end of the second switch module is grounded, and the third end of the second switch module is connected to the first control end of the control module; the first end of the second resistor is connected to the signal input-output end, and the second end of the second resistor is connected to the second direct-current voltage source and the analog-digital conversion end of the control module; the first end of the third resistor is connected to the signal input-output end; the first end of the third switch module is connected to the second end of the third resistor, the second end of the third switch module is grounded, and the third end of the third switch module is connected to the second control end of the control module; the first end of the fourth resistor is connected to the second end of the second resistor; the first end of the fourth switch module is connected to the second end of the fourth resistor, and the second end of the fourth switch module is grounded; the first end of the fifth switch module is connected to the third end of the fourth switch module and the third direct-current voltage source, the second end of the fifth switch module is grounded, and the third end of the fifth switch module is connected to the second control end of the control module; the first end of the amplification module is connected to the digital-analog conversion end of the control module, and the second end of the amplification module is grounded; the first end of the sixth switch module is connected to the third end of the amplification module, the second end of the sixth switch module is connected to the signal input-output end, the third end of the sixth switch module is connected to the third control end of the control module, and the fourth end of the sixth switch module is grounded; and the control module is configured to: control the second switch module to be on or off according to the first control signal output by the first control end; control the fifth switch module and the third switch module to be on or off individually according to the second control signal output by the second control end; and control the sixth switch module to be on or off according to the third control signal output by the third control end, to collect the signal input from the signal input-output end by the analog-digital conversion end, or to output the signal input to the digital-analog conversion end through the signal input-output end. Accordingly, the input-output control circuit could convert the input or output signal with simple operations, thereby improving the universality, safety and reliability of the input-output control circuit.

In addition, the input and output control circuit according to the first aspect of embodiments of the present disclosure may further involve the additional features as follows.

According to an embodiment of the present disclosure, the first switch module includes: a first transistor, where a first end of the first transistor is connected to the first direct-current voltage source, a second end of the first transistor is connected to the first end of the first resistor, and a third end of the first transistor is connected to the first end of the second switch module; and a fifth resistor, where a first end of the fifth resistor is connected to the first end of the first transistor, and a second end of the fifth resistor is connected to the third end of the first transistor.

According to an embodiment of the present disclosure, the second switch module includes: a second transistor, where a first end of the second transistor is connected to the third end of the first switch module, a second end of the second transistor is grounded, and a third end of the second transistor is connected to the first control end.

According to an embodiment of the present disclosure, the third switch module includes: a third transistor, where a first end of the third transistor is connected to the second end of the third resistor, a second end of the third transistor is grounded, and a third end of the third transistor is connected to the second control end; and a sixth resistor, where a first end of the sixth resistor is connected to the third end of the third transistor, and a second end of the sixth resistor is connected to the second end of the third transistor.

According to an embodiment of the present disclosure, the fourth switch module includes: a fourth transistor, where a first end of the fourth transistor is connected to the second end of the fourth resistor, a second end of the fourth transistor is grounded, and a third end of the fourth transistor is connected to the first end of the fifth switch module; and a seventh resistor, where a first end of the seventh resistor is connected to the second end of the fourth transistor, and a second end of the seventh resistor is connected to the third end of the fourth transistor.

According to an embodiment of the present disclosure, the fifth switch module includes: a fifth transistor, where a first end of the fifth transistor is connected to the third direct-current voltage source via an eighth resistor, a second end of the fifth transistor is grounded, and a third end of the fifth transistor is connected to the second control end.

According to an embodiment of the present disclosure, the amplification module includes: an operational amplifier; a ninth resistor, where a first end of the ninth resistor is connected to a non-inverting input end of the operational amplifier, and a second end of the ninth resistor is connected to the digital-analog conversion end; a tenth resistor, where a first end of the tenth resistor is connected to an inverting input end of the operational amplifier, and a second end of the tenth resistor is grounded; an eleventh resistor, where a first end of the eleventh resistor is connected to the first end of the sixth switch module, and a second end of the eleventh resistor is connected to an output end of the operational amplifier; and a twelfth resistor, where a first end of the twelfth resistor is connected to the first end of the eleventh resistor, and a second end of the twelfth resistor is connected to the inverting input end of the operational amplifier.

According to an embodiment of the present disclosure, the sixth switch module includes: a relay, where a first end of the relay is connected to the third end of the amplification module, a second end of the relay is connected to the signal input-output end, a third end of the relay is connected to the third control end via a thirteenth resistor, and a fourth end of the relay is grounded.

According to an embodiment of the present disclosure, the input-output control circuit above further includes: a filtration module, including: a first capacitor, a second capacitor and a fourteenth resistor, in which a first end of the first capacitor is connected to the second end of the second resistor and a first end of the fourteenth resistor, a second end of the first capacitor is grounded, a first end of the second capacitor is connected to the analog-digital conversion end and a second end of the fourteenth resistor, and a second end of the second capacitor is grounded.

According to an embodiment of the present disclosure, the input-output control circuit above further includes: a first voltage stabilizer, where a first end of the first voltage stabilizer is connected to the signal input-output end, and a second end of the first voltage stabilizer is grounded.

According to an embodiment of the present disclosure, the input-output control circuit above further includes: a second voltage stabilizer, where a first end of the second voltage stabilizer is connected to a second direct-current voltage source, a second end of the second voltage stabilizer is connected to the analog-digital conversion end, and a third end of the second voltage stabilizer is grounded.

In order to achieve the above objectives, according to a second aspect of embodiments of the present disclosure, there is provided a controller, including an input-output control circuit according to the first aspect of embodiments of the present disclosure.

The controller according to embodiments of the present disclosure could convert the input or output signal with simple operations, thereby improving the universality, safety and reliability of the input-output control circuit.

In order to achieve the above objectives, according to a third aspect of embodiments of the present disclosure, there is provided an air conditioner, including a controller according to the second aspect of embodiments of the present disclosure.

The air conditioner according to embodiments of the present disclosure could convert the input or output signal with simple operations, thereby improving the universality, safety and reliability of the input-output control circuit.

Additional aspects and advantages of embodiments of the present disclosure will be given in part in the following descriptions, become apparent in part from the following descriptions, or be learned from the practice of the embodiments of the present disclosure.

### BRIEF DESCRIPTION OF THE DRAWINGS

The above and/or additional aspects and advantages of embodiments of the present disclosure will become apparent and more readily appreciated from the following descriptions made with reference to the drawings, in which:

FIG. 1 is a schematic diagram showing an input-output control circuit according to embodiments of the present disclosure;

FIG. 2 is a circuit diagram showing an input-output control circuit according to an embodiment of the present disclosure;

FIG. 3 is a block diagram showing a controller according to an embodiment of the present disclosure; and

FIG. 4 is a block diagram showing an air conditioner according to an embodiment of the present disclosure.

### DETAILED DESCRIPTION

Embodiments of the present disclosure will be described in detail and examples of embodiments are illustrated in the drawings. The same or similar elements and the elements having the same or similar functions are denoted by like reference numerals throughout the descriptions. Embodiments described herein with reference to drawings are explanatory, serve to explain the present disclosure, and are not construed to limit embodiments of the present disclosure.

Reference will be made to an input-output control circuit, controller and air conditioner provided in embodiments of the present disclosure, referring to the accompanying drawings.

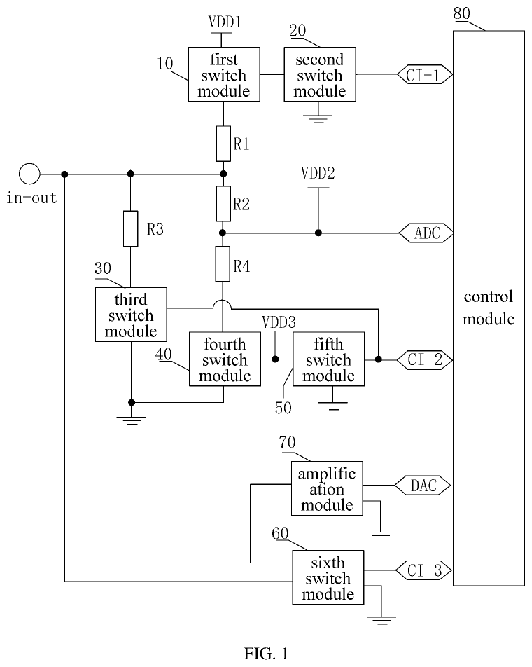

FIG. 1 is a schematic diagram showing an input-output control circuit according to embodiments of the present disclosure.

It should be noted that the input-output control circuit provided in embodiments of the present disclosure is arranged in a controller.

As shown in FIG. 1, according to embodiments of the present disclosure, the input-output control circuit includes: a signal input-output end (in-out), a first switch module (10), a first resistor (R1), a second switch module (20), a second resistor (R2), a third resistor (R3), a third switch module (30), a fourth resistor (R4), a fourth switch module (40), a fifth switch module (50), a sixth switch module (60), an amplification module (70) and a control module (80).

The signal input-output end (in-out) is for inputting or outputting a signal. A first end of a first switch module (10) is connected to a first direct-current voltage source, such as a 10 VDC voltage source. A first end of the first resistor (R1) is connected to a second end of the first switch module (10). A first end of a second switch module (20) is connected to a third end of the first switch module (10), a second end of the second switch module (20) is grounded, and a third end of the second switch module (20) is connected to a first control end (CI-1) of the control module (80). A first end of the second resistor (R2) is connected to the signal input-output end (in-out), and a second end of the second resistor (R2) is connected to a second direct-current voltage source such as a 3.3 VDC voltage source and an analog-digital conversion end (ADC) of the control module (80). A first end of a third resistor (R3) is connected to the signal input-output end (in-out). A first end of a third switch module (30) is connected to the signal input-output end (in-out), a second end of the third switch module (30) is grounded, and a third end of the third switch module (30) is connected to a second control end (CI-2) of the control module (80). A first end of a fourth resistor (R4) is connected to the second end of the second resistor (R2). A first end of a fourth switch module (40) is connected to a second end of the fourth resistor (R4), and a second end of the fourth switch module (40) is grounded. A first end of a fifth switch module (50) is connected to a third end of the fourth switch module (40) and a third direct-current voltage source such as a 5 VDC voltage source, a second end of the fifth switch module (50) is grounded, and a third end of the fifth switch module (50) is connected to the second control end (CI-2) of the control module (80). A first end of an amplification module (70) is connected to a digital-analog conversion end (DAC) of the control module (80), and a second end of the amplification module (70) is grounded. A first end of a sixth switch module (60) is connected to a third end of the amplification module (70), a second end of the sixth switch module (60) is connected to the signal input-output end (in-out), a third end of the sixth switch module (60) is connected to the third control end (CI-3) of the control module (80), and a fourth end of the sixth switch module (60) is grounded. The control module (80) is configured to: control the second switch module (20) to be on or off according to the first control signal output by the first control end (CI-1); control the fifth switch module (50) and the third switch module (30) to be on or off individually according to the second control signal output by the second control end (CI-2); and control the sixth switch module (60) to be on or off according to the third control signal output by the third control end (CI-3), to collect the signal input from the signal input-output end (in-out) by the analog-digital conversion end (ADC), or to output the signal input to the digital-analog conversion end (DAC) through the signal input-output end (in-out).

In specific, based on the input-output end in an input state, the signal input, for example, is a temperature signal, the input-output control circuit is in a resistance collecting mode, and an external resistance-type temperature sensor (RT) is connected to the input-output end. The control module (80) controls the second switch module (20) to be connected according to the first control signal output by the first control end (CI-1), and the second switch module (20) controls the first switch module (10) to be connected; the control module (80) controls the third switch module (30) and the fifth switch module (50) to be disconnected individually, according to the second control signal output by the second control end (CI-2), and the fifth switch module (50) controls the fourth switch module (40) to be connected; and the control module (80) controls the sixth switch module (60) to be disconnected according to the third control signal output by the third control end (CI-3). At this time, the second resistor (R2) and the fourth resistor (R4) are connected in series, and the external resistance-type temperature sensor (RT) is connected in parallel to the series second resistor (R2) and fourth resistor (R4), and is further connected in series to the first resistor (R1). The resistance collecting circuit is supplied with electricity through the first direct-current voltage source, and a voltage signal across the fourth resistor (R4) is collected. The voltage signal is output to the analog-digital conversion end (ADC), and subject to analog-digital conversion performed by the control module (80). At this time, a value of resistance of the external resistance-type temperature sensor (RT) is obtained by the control module (80) based on the collected voltage signal, thereby realizing a collection for the input resistance value.

Based on the input-output end in an input state, the signal input, for example, is a current signal, the input-output control circuit is in a current collecting mode, and a current signal of 0-20 mA is(are) connected to the input-output end. The control module (80) controls the second switch module (20) to be disconnected according to the first control signal output by the first control end (CI-1), and the second switch module (20) controls the first switch module (10) to be disconnected; the control module (80) controls the third switch module (30) and the fifth switch module (50) to be connected individually, according to the second control signal output by the second control end (CI-2), and the fifth switch module (50) controls the fourth switch module (40) to be disconnected; and the control module (80) controls the sixth switch module (60) to be disconnected according to the third control signal output by the third control end (CI-3). At this time, the current signal of 0-20 mA is(are) detected via the third resistor (R3) and is converted to a voltage signal, and the converted voltage signal, after across the second resistor (R2), is output to the analog-digital conversion end (ADC), and subject to analog-digital conversion performed by the control module (80). At this time, a current value of the current signal is obtained by the control module (80), based on the collected voltage signal, thereby realizing a collection for the input current value.

Based on the input-output end in an input state, the signal input, for example, is a voltage signal, the input-output control circuit is in a voltage collecting mode, and a voltage signal of 0-10 V is(are) connected to the input-output end. The control module (80) controls the second switch module (20) to be disconnected according to the first control signal output by the first control end (CI-1), and the second switch module (20) controls the first switch module (10) to be disconnected; the control module (80) controls the third switch module (30) and the fifth switch module (50) to be disconnected individually, according to the second control signal output by the second control end (CI-2), and the fifth switch module (50) controls the fourth switch module (40) to be connected; and the control module (80) controls the sixth switch module (60) to be disconnected according to the third control signal output by the third control end (CI-3). At this time, the voltage signal of 0-10 V is(are) divided by the second resistor (R2) and the fourth resistor (R4) and output to the analog-digital conversion end (ADC), and subject to analog-digital conversion performed by the control module (80). At this time, a voltage value of the voltage signal is obtained by the control module (80), based on the obtained voltage signal, thereby realizing a collection for the input voltage value.

Based on the input-output end in an output state, the signal output, for example, is a voltage signal, the input-output control circuit is in a voltage outputting mode, and the control module (80) inputs a voltage signal of 0-10 V to the digital-analog conversion end. The control module (80) controls the second switch module (20) to be disconnected according to the first control signal output by the first control end (CI-1), and the second switch module (20) controls the first switch module (10) to be disconnected; the control module (80) controls the third switch module (30) and the fifth switch module (50) to be disconnected individually, according to the second control signal output by the second control end (CI-2), and the fifth switch module (50) controls the fourth switch module (40) to be connected; and the control module (80) controls the sixth switch module (60) to be connected according to the third control signal output by the third control end (CI-3). At this time, the voltage signal of 0-10 V is operationally amplified by the amplification module (70), and a voltage signal of 0-10 V is(are) output to the input-output end. That is, a voltage signal of 0-10 V is(are) output from the input-output end. At this time, the voltage signal of 0-10 V is(are) divided by the second resistor (R2) and the fourth resistor (R4), and the analog-digital conversion end (ADC) collects a voltage across the fourth resistor (R4), thereby realizing a collection for the input voltage.

Based on that a dry-contact (electrical independent contact) signal is input via the input-output end, the control module (80) controls the second switch module (20) to be connected according to the first control signal output by the first control end (CI-1), and the second switch module (20) controls the first switch module (10) to be connected; the control module (80) controls the third switch module (30) and the fifth switch module (50) to be disconnected individually, according to the second control signal output by the second control end (CI-2), and the fifth switch module (50) controls the fourth switch module (40) to be connected; and the control module (80) controls the sixth switch module (60) to be disconnected according to the third control signal output by the third control end (CI-3). At this time, based on the input-output end is disconnected, a voltage collected by the analog-digital conversion end (ADC) is about 10 V; while based on the input-output end is connected, a voltage collected by the analog-digital conversion end (ADC) is about 0 V, such that the analog-digital conversion end (ADC) could judge whether the input-output end is on or off, according to the maximum value and the minimum value of the collected voltage value, thereby realizing the monitoring of digital quantity.

Accordingly, the input-output control circuit could convert the input or output signal with simple operations, thereby improving the universality, safety and reliability of the input and output control circuit.

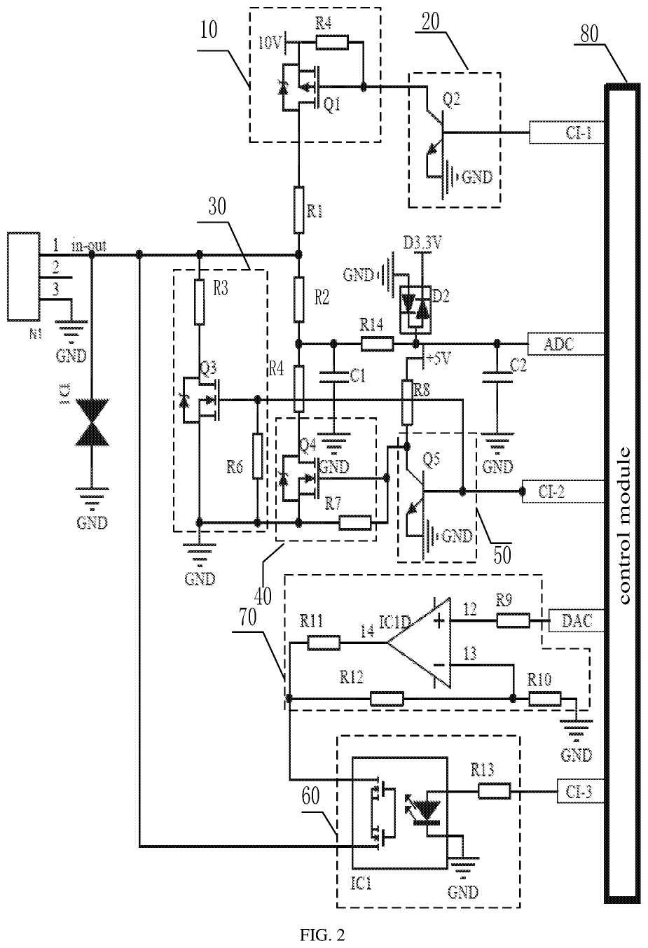

Reference will be made to the input-output control circuit provided in embodiments of the present disclosure, referring to FIG. 2.

As shown in FIG. 2, the first switch module (10) includes: a first transistor (Q1) and a fifth resistor (R5). A first end of the first transistor (Q1) is connected to the first direct-current voltage source, a second end of the first transistor (Q1) is connected to the first end of the first resistor (R1), and a third end of the first transistor (Q1) is connected to the first end of the second switch module (20). A first end of the fifth resistor (R5) is connected to the first end of the first transistor (Q1), and a second end of the fifth resistor (R5) is connected to the third end of the first transistor (Q1). The first transistor (Q1) may be a P-type metal-oxide semiconductor (MOS) transistor.

As shown in FIG. 2, the second switch module (20) includes: a second transistor (Q2), where a first end of the second transistor (Q2) is connected to the third end of the first switch module (10), a second end of the second transistor (Q2) is grounded, and a third end of the second transistor (Q2) is connected to the first control end (CI-1). The second transistor (Q2) may be a NPP-type triode.

As shown in FIG. 2, the third switch module (30) includes a third transistor (Q3) and a sixth resistor (R6). A first end of the third transistor (Q3) is connected to the second end of the third resistor (R3), a second end of the third transistor (Q3) is grounded, and a third end of the third transistor (Q3) is connected to the second control end (CI-2). A first end of the sixth resistor (R6) is connected to the third end of the third transistor (Q3), and a second end of the sixth resistor (R6) is connected to the second end of the third transistor (Q3). The third transistor (Q3) may be an N-type MOS transistor.

As shown in FIG. 2, the fourth switch module (40) includes: a fourth transistor (Q4) and a seventh resistor (R7). A first end of the fourth transistor (Q4) is connected to the second end of the fourth resistor (R4), a second end of the fourth transistor (Q4) is grounded, and a third end of the fourth transistor (Q4) is connected to the first end of the fifth switch module (50). A first end of the seventh resistor (R7) is connected to the second end of the fourth transistor (Q4), and a second end of the seventh resistor (R7) is connected to the third end of the fourth transistor (Q4). The fourth transistor (Q4) may be an N-type MOS transistor.

As shown in FIG. 2, the fifth switch module (50) includes: a fifth transistor (Q5), where a first end of the fifth transistor (Q5) is connected to the third direct-current voltage source via an eighth resistor, a second end of the fifth transistor (Q5) is grounded, and a third end of the fifth transistor (Q5) is connected to the second control end (CI-2). The fifth transistor (Q5) may be a NPN-type triode.

As shown in FIG. 2, the amplification module (70) includes: an operational amplifier (ICID), a ninth resistor (R9), a tenth resistor (R10), an eleventh resistor (R11), and a twelfth resistor (R12). A first end of the ninth resistor (R9) is connected to a non-inverting input end of the operational amplifier (ICID), and a second end of the ninth resistor (R9) is connected to the digital-analog conversion end (DAC). A first end of the tenth resistor (R10) is connected to an inverting input end of the operational amplifier (ICID), and a second end of the tenth resistor (R10) is grounded. A first end of the eleventh resistor (R11) is connected to the first end of the sixth switch module (60), and a second end of the eleventh resistor (R11) is connected to an output end of the operational amplifier (ICID). A first end of the twelfth resistor (R12) is connected to the first end of the eleventh resistor (R11), and a second end of the twelfth resistor (R12) is connected to the inverting input end of the operational amplifier (ICID).

As shown in FIG. 2, the sixth switch module (60) includes: a relay (IC1), where a first end of the relay (IC1) is connected to the third end of the amplification module (70), a second end of the relay (IC1) is connected to the signal input-output end (in-out), a third end of the relay (IC1) is connected to the third control end (CI-3) via a thirteenth resistor, and a fourth end of the relay (IC1) is grounded. The relay (IC1) may be a solid state relay (IC1), an electromagnetic relay (IC1) and the like.

As shown in FIG. 2, the input-output control circuit above further includes: a filtration module, including: a first capacitor (C1), a second capacitor (C2) and a fourteenth resistor (R14), in which a first end of the first capacitor (C1) is connected to the second end of the second resistor (R2) and a first end of the fourteenth resistor (R14), a second end of the first capacitor (C1) is grounded, a first end of the second capacitor (C2) is connected to the analog-digital conversion end (ADC) and a second end of the fourteenth resistor (R14), and a second end of the second capacitor (C2) is grounded.

As shown in FIG. 2, the input-output control circuit above further includes: a first voltage stabilizer (D1), where a first end of the first voltage stabilizer (D1) is connected to the signal input-output end (in-out), and a second end of the first voltage stabilizer (D1) is grounded.

As shown in FIG. 2, the input-output control circuit above further includes: a second voltage stabilizer (D2), where a first end of the second voltage stabilizer (D2) is connected to a second direct-current voltage source such as a 3.3 VDC voltage source, a second end of the second voltage stabilizer (D2) is connected to the analog-digital conversion end (ADC), and a third end of the second voltage stabilizer (D2) is grounded.

In specific, based on the input-output end in an input state, the signal input, for example, is a temperature signal, the input-output control circuit is in a resistance collecting mode, and an external resistance-type temperature sensor (RT) is connected to the input-output end. The control module (80) controls the second transistor (Q2) and the first transistor (Q1) to be connected according to a high-level signal output by the first control end (CI-1); the control module (80) individually controls the third transistor (Q3) and the fifth transistor (Q5) to be disconnected, as well as the fourth transistor (Q4) to be connected according to a low-level signal output by the second control end (CI-2); and the control module (80) controls the relay (IC1) to be disconnected according to a low-level signal output by the third control end (CI-3). At this time, the second resistor (R2) and the fourth resistor (R4) are connected in series, and the external resistance-type temperature sensor (RT) is connected in parallel to the series second resistor (R2) and fourth resistor (R4), and is further connected in series to the first resistor (R1). The resistance collecting circuit is supplied with electricity through the first direct-current voltage source, and a voltage signal across the fourth resistor (R4) is collected. The voltage signal is filtered by the filtration module and output to the analog-digital conversion end (ADC), so as to perform analog-digital conversion, by the control module (80), on the voltage signal. At this time, a value of resistance of the external resistance-type temperature sensor (RT) is obtained by the control module (80) based on the collected voltage signal, thereby realizing a collection for the input resistance value.

Based on the input-output end in an input state, the signal input, for example, is a current signal, the input-output control circuit is in a current collecting mode, and a current signal of 0-20 mA is(are) connected to the input-output end. The control module (80) controls the second transistor (Q2) and the first transistor (Q1) to be disconnected according to a low-level signal output by the first control end (CI-1); the control module (80) individually controls the third transistor (Q3) and the fifth transistor (Q5) to be connected, as well as the fourth transistor (Q4) to be disconnected according to a high-level signal output by the second control end (CI-2); and the control module (80) controls the relay (IC1) to be disconnected according to a low-level signal output by the third control end (CI-3). At this time, the current signal of 0-20 mA is(are) detected via the third resistor (R3) and is converted to a voltage signal, and the converted voltage signal, after across the second resistor (R2), is filtered by the filtration module and output to the analog-digital conversion end (ADC), and the voltage signal is performed with analog-digital conversion by the control module (80). At this time, a current value of the current signal is obtained by the control module (80), based on the collected voltage signal, thereby realizing a collection for the input current value.

Based on the input-output end in an input state, the signal input, for example, is a voltage signal, the input-output control circuit is in a voltage collecting mode, and a voltage signal of 0-10 V is(are) connected to the input-output end. The control module (80) controls the second transistor (Q2) and the first transistor (Q1) to be disconnected according to a low-level signal output by the first control end (CI-1); the control module (80) individually controls the third transistor (Q3) and the fifth transistor (Q5) to be disconnected, as well as the fourth transistor (Q4) to be connected according to a low-level signal output by the second control end (CI-2); and the control module (80) controls the relay (IC1) to be disconnected according to a low-level signal output by the third control end (CI-3). At this time, the voltage signal of 0-10 V is(are) divided by the second resistor (R2) and the fourth resistor (R4) and then filtered by the filtration module, and is output to the analog-digital conversion end (ADC), and the voltage signal is performed with analog-digital conversion by the control module (80). At this time, a voltage value of the voltage signal is obtained by the control module (80), based on the obtained voltage signal, thereby realizing a collection for the input voltage value.

Based on the input-output end in an output state, the signal output, for example, is a voltage signal, the input-output control circuit is in a voltage outputting mode, and the control module (80) inputs a voltage signal of 0-10 V to the digital-analog conversion end (DAC). The control module (80) controls the second transistor (Q2) and the first transistor (Q1) to be disconnected according to a low-level signal output by the first control end (CI-1); the control module (80) individually controls the third transistor (Q3) and the fifth transistor (Q5) to be disconnected, as well as the fourth transistor (Q4) to be connected according to a low-level signal output by the second control end (CI-2); and the control module (80) controls the relay (IC1) to be connected according to a high-level signal output by the third control end (CI-3). At this time, the voltage signal of 0-10 V is operationally amplified by the amplification module (70), and a voltage signal of 0-10 V is(are) output to the input-output end. That is, a voltage signal of 0-10 V is(are) output from the input-output end. At this time, the voltage signal of 0-10 V is(are) divided by the second resistor (R2) and the fourth resistor (R4), and the analog-digital conversion end (ADC) collects a voltage across the fourth resistor (R4), thereby realizing a collection for the input voltage.

Based on that a dry-contact (electrical independent contact) signal is input via the input-output end, the control module (80) controls the second transistor (Q2) and the first transistor (Q1) to be connected according to a high-level signal output by the first control end (CI-1); the control module (80) individually controls the third transistor (Q3) and the fifth transistor (Q5) to be disconnected, as well as the fourth transistor (Q4) to be connected according to a low-level signal output by the second control end (CI-2); and the control module (80) controls the relay (IC1) to be disconnected according to a low-level signal output by the third control end (CI-3). At this time, based on the input-output end is disconnected, a voltage collected by the analog-digital conversion end (ADC) is about 10 V; while based on the input-output end is connected, a voltage collected by the analog-digital conversion end (ADC) is about 0 V, such that the analog-digital conversion end (ADC) could judge whether the input-output end is on or off, according to the maximum value and the minimum value of the collected voltage value, thereby realizing the monitoring of digital quantity.

It should be noted that a current signal may be further output from the input-output end.

In summary, the input-output control circuit includes: the signal input-output end, the first switch module, the first resistor, the second switch module, the second resistor, the third resistor, the third switch module, the fourth resistor, the fourth switch module, the fifth switch module, the amplification module, the sixth switch module and the controller module, where the signal input-output end is for inputting or outputting a signal; the first end of the first switch module is connected to the first direct-current voltage source; the first end of the first resistor is connected to the second end of the first switch module; the first end of the second switch module is connected to the third end of the first switch module, the second end of the second switch module is grounded, and the third end of the second switch module is connected to the first control end of the control module; the first end of the second resistor is connected to the signal input-output end, and the second end of the second resistor is connected to the second direct-current voltage source and the analog-digital conversion end of the control module; the first end of the third resistor is connected to the signal input-output end; the first end of the third switch module is connected to the second end of the third resistor, the second end of the third switch module is grounded, and the third end of the third switch module is connected to the second control end of the control module; the first end of the fourth resistor is connected to the second end of the second resistor; the first end of the fourth switch module is connected to the second end of the fourth resistor, and the second end of the fourth switch module is grounded; the first end of the fifth switch module is connected to the third end of the fourth switch module and the third direct-current voltage source, the second end of the fifth switch module is grounded, and the third end of the fifth switch module is connected to the second control end of the control module; the first end of the amplification module is connected to the digital-analog conversion end of the control module, and the second end of the amplification module is grounded; the first end of the sixth switch module is connected to the third end of the amplification module, the second end of the sixth switch module is connected to the signal input-output end, the third end of the sixth switch module is connected to the third control end of the control module, and the fourth end of the sixth switch module is grounded; and the control module is configured to: control the second switch module to be on or off according to the first control signal output by the first control end; control the fifth switch module and the third switch module to be on or off individually according to the second control signal output by the second control end; and control the sixth switch module to be on or off according to the third control signal output by the third control end, to collect the signal input from the signal input-output end by the analog-digital conversion end, or to output the signal input to the digital-analog conversion end through the signal input-output end. Accordingly, the input-output control circuit could convert the input or output signal with simple operations, thereby improving the universality, safety and reliability of the input-output control circuit.

For achieving the above embodiments, embodiments of the present disclosure further provide a controller.

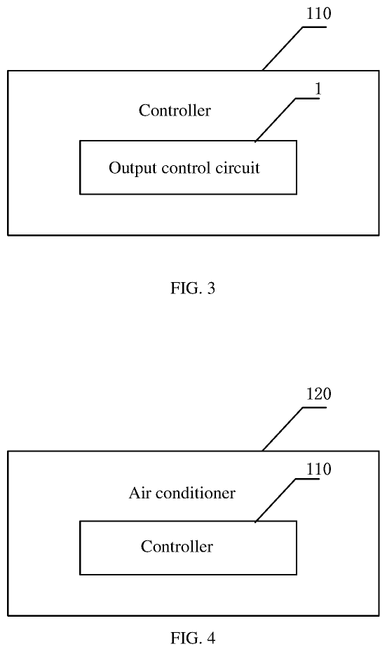

As shown in FIG. 3, the controller (110) provided in embodiments of the present disclosure may specifically include: an input-output control circuit according to any one of the above embodiments of the present disclosure.

The controller according to embodiments of the present disclosure could convert the input or output signal, thereby improving the universality, safety and reliability of the input and output control circuit.

For achieving the above embodiments, embodiments of the present disclosure further provide an air conditioner 120.

As shown in FIG. 4, the air conditioner 120 provided in embodiments of the present disclosure may specifically include: a controller (110) as shown in FIG. 3.

The air conditioner according to embodiments of the present disclosure could convert the input or output signal thereby improving the universality, safety and reliability of the input and output control circuit.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments”, “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples. Besides, any different embodiments and examples and any different characteristics of embodiments and examples may be combined by those skilled in the art without contradiction.

Although explanatory embodiments have been shown and described, it would be appreciated by those skilled in the art that the above embodiments cannot be construed to limit the present disclosure, and changes, alternatives, and modifications can be made in the embodiments in the scope of the present disclosure.

1. An input-output control circuit, wherein the input-output control circuit is arranged in a controller, and the input-output control circuit comprises:
a signal input-output end for inputting or outputting a signal;
a first switch module, wherein a first end of the first switch module is connected to a first direct-current voltage source;
a first resistor, wherein a first end of the first resistor is connected to a second end of the first switch module;
a second switch module, wherein a first end of the second switch module is connected to a third end of the first switch module, a second end of the second switch module is grounded, and a third end of the second switch module is connected to a first control end of a control module;
a second resistor, wherein a first end of the second resistor is connected to the signal input-output end, and a second end of the second resistor is connected to a second direct-current voltage source and an analog-digital conversion end of the control module;
a third resistor, wherein a first end of the third resistor is connected to the signal input-output end;
a third switch module, wherein a first end of the third switch module is connected to a second end of the third resistor, a second end of the third switch module is grounded, and a third end of the third switch module is connected to a second control end of the control module;
a fourth resistor, wherein a first end of the fourth resistor is connected to the second end of the second resistor;
a fourth switch module, wherein a first end of the fourth switch module is connected to a second end of the fourth resistor, and a second end of the fourth switch module is grounded;
a fifth switch module, wherein a first end of the fifth switch module is connected to a third end of the fourth switch module and a third direct-current voltage source, a second end of the fifth switch module is grounded, and a third end of the fifth switch module is connected to the second control end of the control module;
an amplification module, wherein a first end of the amplification module is connected to a digital-analog conversion end of the control module, and a second end of the amplification module is grounded;
a sixth switch module, wherein a first end of the sixth switch module is connected to a third end of the amplification module, a second end of the sixth switch module is connected to the signal input-output end, a third end of the sixth switch module is connected to a third control end of the control module, and a fourth end of the sixth switch module is grounded; and
the control module, configured to: control the second switch module to be on or off according to a first control signal output by the first control end; control the fifth switch module and the third switch module to be on or off individually according to a second control signal output by the second control end; and control the sixth switch module to be on or off according to a third control signal output by the third control end, to collect the signal input from the signal input-output end by the analog-digital conversion end, or to output the signal input to the digital-analog conversion end through the signal input-output end.

2. The input-output control circuit according to claim 1, wherein the first switch module comprises:
a first transistor, wherein a first end of the first transistor is connected to the first direct-current voltage source, a second end of the first transistor is connected to the first end of the first resistor, and a third end of the first transistor is connected to the first end of the second switch module; and
a fifth resistor, wherein a first end of the fifth resistor is connected to the first end of the first transistor, and a second end of the fifth resistor is connected to the third end of the first transistor.

3. The input-output control circuit according to claim 1, wherein the second switch module comprises:
a second transistor, wherein a first end of the second transistor is connected to the third end of the first switch module, a second end of the second transistor is grounded, and a third end of the second transistor is connected to the first control end.

4. The input-output control circuit according to claim 1, wherein the third switch module comprises:
a third transistor, wherein a first end of the third transistor is connected to the second end of the third resistor, a second end of the third transistor is grounded, and a third end of the third transistor is connected to the second control end; and
a sixth resistor, wherein a first end of the sixth resistor is connected to the third end of the third transistor, and a second end of the sixth resistor is connected to the second end of the third transistor.

5. The input-output control circuit according to claim 1, wherein the fourth switch module comprises:
a fourth transistor, wherein a first end of the fourth transistor is connected to the second end of the fourth resistor, a second end of the fourth transistor is grounded, and a third end of the fourth transistor is connected to the first end of the fifth switch module; and
a seventh resistor, wherein a first end of the seventh resistor is connected to the second end of the fourth transistor, and a second end of the seventh resistor is connected to the third end of the fourth transistor.

6. The input-output control circuit according to claim 1, wherein the fifth switch module comprises:
a fifth transistor, wherein a first end of the fifth transistor is connected to the third direct-current voltage source via an eighth resistor, a second end of the fifth transistor is grounded, and a third end of the fifth transistor is connected to the second control end.

7. The input-output control circuit according to claim 1, wherein the amplification module comprises:
an operational amplifier;
a ninth resistor, wherein a first end of the ninth resistor is connected to a non-inverting input end of the operational amplifier, and a second end of the ninth resistor is connected to the digital-analog conversion end;
a tenth resistor, wherein a first end of the tenth resistor is connected to an inverting input end of the operational amplifier, and a second end of the tenth resistor is grounded;
an eleventh resistor, wherein a first end of the eleventh resistor is connected to the first end of the sixth switch module, and a second end of the eleventh resistor is connected to an output end of the operational amplifier; and
a twelfth resistor, wherein a first end of the twelfth resistor is connected to the first end of the eleventh resistor, and a second end of the twelfth resistor is connected to the inverting input end of the operational amplifier.

8. The input-output control circuit according to claim 1, wherein the sixth switch module comprises:
a relay, wherein a first end of the relay is connected to the third end of the amplification module, a second end of the relay is connected to the signal input-output end, a third end of the relay is connected to the third control end via a thirteenth resistor, and a fourth end of the relay is grounded.

9. The input-output control circuit according to claim 1, further comprising:
a filtration module, comprising: a first capacitor, a second capacitor and a fourteenth resistor, wherein
a first end of the first capacitor is connected to the second end of the second resistor and a first end of the fourteenth resistor, a second end of the first capacitor is grounded,
a first end of the second capacitor is connected to the analog-digital conversion end and a second end of the fourteenth resistor, and a second end of the second capacitor is grounded.

10. The input-output control circuit according to claim 1, further comprising:
a first voltage stabilizer, wherein a first end of the first voltage stabilizer is connected to the signal input-output end, and a second end of the first voltage stabilizer is grounded.

11. The input-output control circuit according to claim 1, further comprising:
a second voltage stabilizer, wherein a first end of the second voltage stabilizer is connected to a second direct-current voltage source, a second end of the second voltage stabilizer is connected to the analog-digital conversion end, and a third end of the second voltage stabilizer is grounded.

12. A controller, comprising the input-output control circuit according to claim 1.

13. An air conditioner, comprising the controller according to claim 12.
